(19) United States
(12) Patent Application Publication
(10) Pub. No.: US 2022/0366656 A1
(43) Pub. Date: Nov. 17, 2022

(54) Method and Device for Generating a Map from a Photo Set

(71) Applicant: Apple Inc., Cupertino, CA (US)

(72) Inventor: Ian M. Richter, Los Angeles, CA (US)

(21) Appl. No.: 17/764,378

(22) PCT Filed: Sep. 22, 2020
(86) PCT No.: PCT/US2020/051921

§ 371 Date: Mar. 28, 2022

Related U.S. Application Data
(60) Provisional application No. 62/906,951, filed on Sep. 27, 2019.

(51) Int. Cl. G06T 19/00; G01C 21/00

(52) U.S. Cl. CPC G06T 19/006; G01C 21/383

(57) ABSTRACT

In one implementation, a method of generating an enhanced reality (ER) map is performed by a device including one or more processors and non-transitory memory. The method includes selecting ER setting representations based on clusters of images and displaying an ER map including the ER setting representations along a path.

### TECHNICAL FIELD

The present disclosure generally relates to generating a map from a photo set.

### BACKGROUND

A physical setting refers to a physical world that people can sense and/or interact with without aid of electronic systems. Physical settings, such as a physical park, include physical elements, such as physical trees, physical buildings, and physical people. People can directly sense and/or interact with the physical setting, such as through sight, touch, hearing, taste, and smell.

In contrast, an enhanced reality (ER) setting refers to a wholly or partially simulated setting that people sense and/or interact with via an electronic system. In ER, a subset of a person's physical motions, or representations thereof, are tracked, and, in response, one or more characteristics of one or more virtual objects simulated in the ER setting are adjusted in a manner that comports with at least one law of physics. For example, an ER system may detect a person's head turning and, in response, adjust graphical content and an acoustic field presented to the person in a manner similar to how such views and sounds would change in a physical setting. In some situations (e.g., for accessibility reasons), adjustments to characteristic(s) of virtual object(s) in an ER setting may be made in response to representations of physical motions (e.g., vocal commands).

A person may sense and/or interact with an ER object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical setting with or without computer-generated audio. In some ER settings, a person may sense and/or interact only with audio objects.

Examples of ER include virtual reality and mixed reality.

A virtual reality (VR) setting refers to an enhanced setting that is designed to be based entirely on computer-generated sensory inputs for one or more senses. A VR setting comprises a plurality of virtual objects with which a person may sense and/or interact. For example, computer-generated imagery of trees, buildings, and avatars representing people are examples of virtual objects. A person may sense and/or interact with virtual objects in the VR setting through a simulation of the person's presence within the computer-generated setting, and/or through a simulation of a subset of the person's physical movements within the computer-generated setting.

In contrast to a VR setting, which is designed to be based entirely on computer-generated sensory inputs, a mixed reality (MR) setting refers to an enhanced setting that is designed to incorporate sensory inputs from the physical setting, or a representation thereof, in addition to including computer-generated sensory inputs (e.g., virtual objects). On a virtuality continuum, a mixed reality setting is anywhere between, but not including, a wholly physical setting at one end and virtual reality setting at the other end.

In some MR settings, computer-generated sensory inputs may respond to changes in sensory inputs from the physical setting. Also, some electronic systems for presenting an MR setting may track location and/or orientation with respect to the physical setting to enable virtual objects to interact with real objects (that is, physical elements from the physical setting or representations thereof). For example, a system may account for movements so that a virtual tree appears stationery with respect to the physical ground.

Examples of mixed realities include augmented reality and augmented virtuality.

An augmented reality (AR) setting refers to an enhanced setting in which one or more virtual objects are superimposed over a physical setting, or a representation thereof. For example, an electronic system for presenting an AR setting may have a transparent or translucent display through which a person may directly view the physical environment. The system may be configured to present virtual objects on the transparent or translucent display, so that a person, using the system, perceives the virtual objects superimposed over the physical setting. Alternatively, a system may have an opaque display and one or more imaging sensors that capture images or video of the physical setting, which are representations of the physical setting. The system composites the images or video with virtual objects, and presents the composition on the opaque display. A person, using the system, indirectly views the physical setting by way of the images or video of the physical setting, and perceives the virtual objects superimposed over the physical setting. As used herein, a video of the physical setting shown on an opaque display is called “pass-through video,” meaning a system uses one or more image sensor(s) to capture images of the physical setting, and uses those images in presenting the AR setting on the opaque display. Further alternatively, a system may have a projection system that projects virtual objects into the physical setting, for example, as a hologram or on a physical surface, so that a person, using the system, perceives the virtual objects superimposed over the physical setting.

An augmented reality setting also refers to an enhanced setting in which a representation of a physical setting is transformed by computer-generated sensory information. For example, in providing pass-through video, a system may transform one or more sensor images to impose a select perspective (e.g., viewpoint) different than the perspective captured by the imaging sensors. As another example, a representation of a physical setting may be transformed by graphically modifying (e.g., enlarging) portions thereof, such that the modified portion may be representative but not photorealistic versions of the originally captured images. As a further example, a representation of a physical setting may be transformed by graphically eliminating or obfuscating portions thereof.

An augmented virtuality (AV) setting refers to an enhanced setting in which a virtual or computer-generated setting incorporates one or more sensory inputs from the physical setting. The sensory inputs may be representations of one or more characteristics of the physical setting. For example, an AV park may have virtual trees and virtual buildings, but people with faces photorealistically reproduced from images taken of physical people. As another example, a virtual object may adopt a shape or color of a physical element imaged by one or more imaging sensors. As a further example, a virtual object may adopt shadows consistent with the position of the sun in the physical setting.

There are many different types of electronic systems that enable a person to sense and/or interact with various ER settings. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one implementation, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

A digital photograph often includes, in addition to a matrix of pixels defining a picture, metadata regarding the picture, e.g., where and when the picture was taken. With a large enough set of digital photographs, this metadata can be mined to generate ER content associated with the set of digital photographs.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example operating architecture in accordance with some implementations.

FIG. 2 is a block diagram of an example controller in accordance with some implementations.

FIG. 3 is a block diagram of an example electronic device in accordance with some implementations.

FIG. 4 illustrates a setting with an electronic device surveying the setting.

FIGS. 5A-5F illustrate a portion of the display of the electronic device of FIG. 4 displaying images of a representation of the setting including a first ER map.

FIG. 6 illustrates the setting of FIG. 4 with the electronic device surveying the setting.

FIGS. 7A-7G illustrate a portion of the display of the electronic device of FIG. 4 displaying images of a representation of the setting including a second ER map.

FIG. 8A illustrates an image set in accordance with some implementations.

FIG. 8B illustrates a cluster table in accordance with some implementations.

FIG. 8C illustrates an ER map object in accordance with some implementations.

FIG. 9 is a flowchart representation of a method of generating an ER map in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for generating an ER map. In various implementations, the method is performed at a device including one or more processors and non-transitory memory. In one implementation, a method of generating an ER map is performed by a device including one or more processors and non-transitory memory. The method includes obtaining a plurality of first images associated with a first user, wherein each of the plurality of first images is further associated with a respective first time and a respective first location. The method includes determining, from the respective first times and respective first locations, a plurality of first clusters and a plurality of respective first cluster times respectively associated with the plurality of first clusters, wherein each of the plurality of first clusters represents a subset of the plurality of first images. The method includes obtaining, based on the plurality of first clusters, a plurality of first ER setting representations. The method includes determining a first path and a plurality of respective first ER locations for the plurality of first ER setting representations along the first path, wherein the first path is defined by an ordered set of first locations including the plurality of respective first ER locations in an order based on the plurality of respective first cluster times. The method includes displaying an ER map including the plurality of first ER setting representations displayed at the plurality of respective first ER locations, wherein each of the plurality of first ER setting representations is associated with an affordance which, when selected, causes display of a respective first ER setting.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

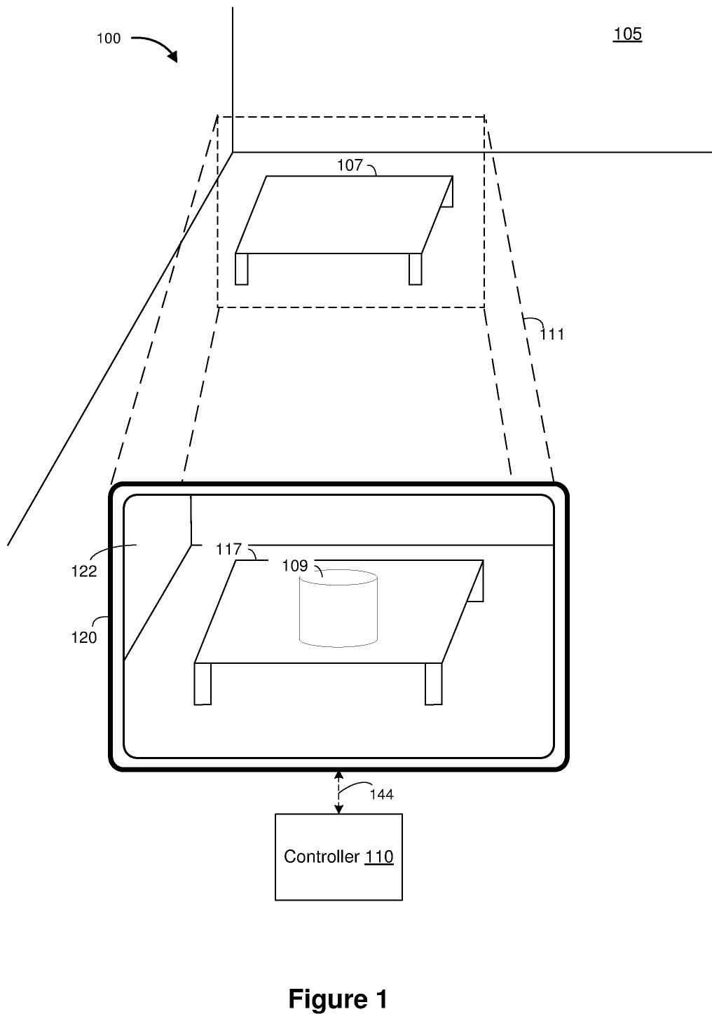

FIG. 1 is a block diagram of an example operating architecture 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating architecture 100 includes an electronic device 120.

In some implementations, the electronic device 120 is configured to present ER content to a user. In some implementations, the electronic device 120 includes a suitable combination of software, firmware, and/or hardware. According to some implementations, the electronic device 120 presents, via a display 122, ER content to the user while the user is physically present within a physical setting 105 that includes a table 107 within the field-of-view 111 of the electronic device 120. As such, in some implementations, the user holds the electronic device 120 in his/her hand(s). In some implementations, the electronic device 120 is configured to display a virtual object (e.g., a virtual cylinder 109) and to enable video pass-through of the physical setting 105 (e.g., including a representation 117 of the table 107) on a display 122.

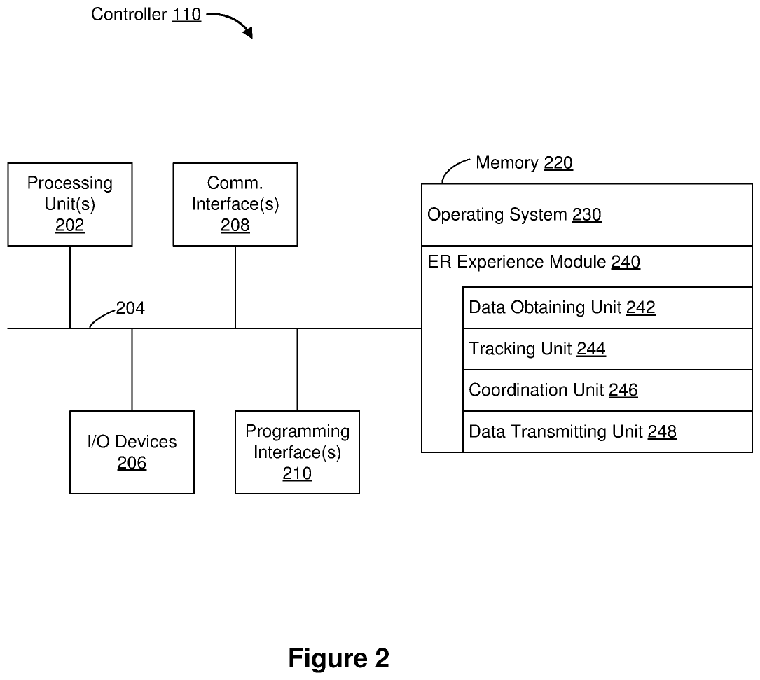

In some implementations, the controller 110 is configured to manage and coordinate presentation of ER content for the user. In some implementations, the controller 110 includes a suitable combination of software, firmware, and/or hardware. The controller 110 is described in greater detail below with respect to FIG. 2. In some implementations, the controller 110 is a computing device that is local or remote relative to the physical setting 105. For example, the controller 110 is a local server located within the physical setting 105. In another example, the controller 110 is a remote server located outside of the physical setting 105 (e.g., a cloud server, central server, etc.). In some implementations, the controller 110 is communicatively coupled with the electronic device 120 via one or more wired or wireless communication channels 144 (e.g., BLUETOOTH, IEEE 802.11x, IEEE 802.16x, IEEE 802.3x, etc.). In another example, the controller 110 is included within the enclosure of the electronic device 120.

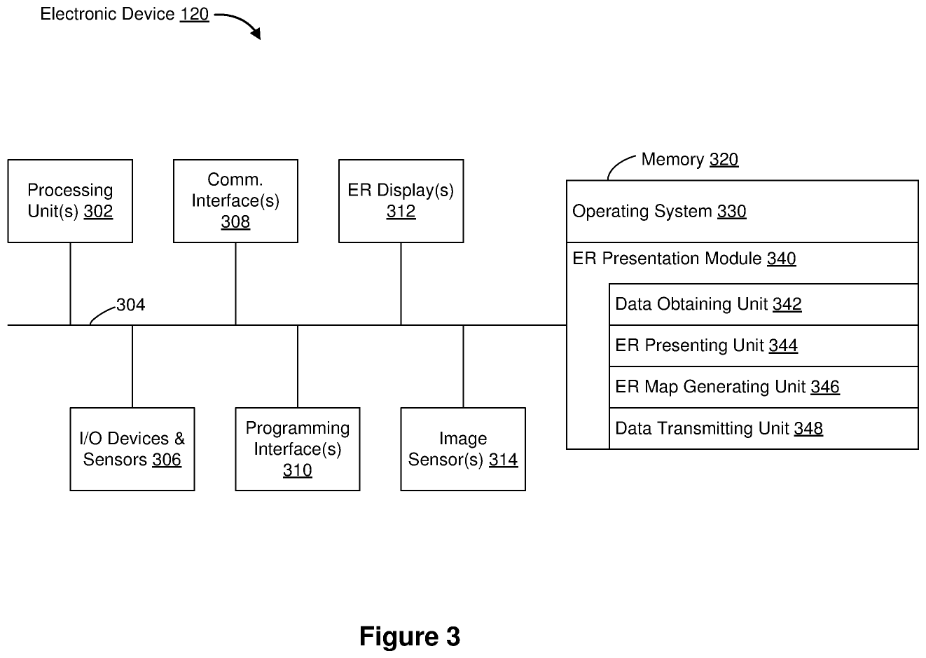

In some implementations, the electronic device 120 is configured to present the ER content to the user. In some implementations, the electronic device 120 includes a suitable combination of software, firmware, and/or hardware. The electronic device 120 is described in greater detail below with respect to FIG. 3. In some implementations, the functionalities of the controller 110 are provided by and/or combined with the electronic device 120.

According to some implementations, the electronic device 120 presents ER content to the user while the user is virtually and/or physically present within the physical setting 105.

In some implementations, the user wears the electronic device 120 on his/her head. For example, in some implementations, the electronic device includes a head-mounted system (HMS), head-mounted device (HMD), or head-mounted enclosure (HME). As such, the electronic device 120 includes one or more ER displays provided to display the ER content. For example, in various implementations, the electronic device 120 encloses the field-of-view of the user. In some implementations, the electronic device 120 is a handheld device (such as a smartphone or tablet) configured to present ER content, and rather than wearing the electronic device 120, the user holds the device with a display directed towards the field-of-view of the user and a camera directed towards the physical setting 105. In some implementations, the handheld device can be placed within an enclosure that can be worn on the head of the user. In some implementations, the electronic device 120 is replaced with an ER chamber, enclosure, or room configured to present ER content in which the user does not wear or hold the electronic device 120.

FIG. 2 is a block diagram of an example of the controller 110 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some implementations, the one or more communication buses 204 include circuitry that interconnects and controls communications between system components. In some implementations, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some implementations, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some implementations, the memory 220 or the non-transitory computer readable storage medium of the memory 220 stores the following programs, modules and data structures, or a subset thereof including an optional operating system 230 and an ER content module 240.

The operating system 230 includes procedures for handling various basic system services and for performing hardware dependent tasks. In some implementations, the ER content module 240 is configured to manage and coordinate presentation of ER content for one or more users (e.g., a single set of ER content for one or more users, or multiple sets of ER content for respective groups of one or more users). To that end, in various implementations, the ER content module 240 includes a data obtaining unit 242, a tracking unit 244, a coordination unit 246, and a data transmitting unit 248.

In some implementations, the data obtaining unit 242 is configured to obtain data (e.g., presentation data, interaction data, sensor data, location data, etc.) from at least the electronic device 120 of FIG. 1. To that end, in various implementations, the data obtaining unit 242 includes instructions and/or logic therefor, and heuristics and metadata therefor.

In some implementations, the tracking unit 244 is configured to map the physical setting 105 and to track the position/location of at least the electronic device 120 with respect to the physical setting 105 of FIG. 1. To that end, in various implementations, the tracking unit 244 includes instructions and/or logic therefor, and heuristics and metadata therefor.

In some implementations, the coordination unit 246 is configured to manage and coordinate the presentation of ER content to the user by the electronic device 120. To that end, in various implementations, the coordination unit 246 includes instructions and/or logic therefor, and heuristics and metadata therefor.

In some implementations, the data transmitting unit 248 is configured to transmit data (e.g., presentation data, location data, etc.) to at least the electronic device 120. To that end, in various implementations, the data transmitting unit 248 includes instructions and/or logic therefor, and heuristics and metadata therefor.

Although the data obtaining unit 242, the tracking unit 244, the coordination unit 246, and the data transmitting unit 248 are shown as residing on a single device (e.g., the controller 110), it should be understood that in other implementations, any combination of the data obtaining unit 242, the tracking unit 244, the coordination unit 246, and the data transmitting unit 248 may be located in separate computing devices.

Moreover, FIG. 2 is intended more as functional description of the various features that may be present in a particular implementation as opposed to a structural schematic of the implementations described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 3 is a block diagram of an example of the electronic device 120 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 120 includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more ER displays 312, one or more optional interior-facing and/or exterior-facing image sensors 314, a memory 320, and one or more communication buses 304 for interconnecting these and various other components.

In some implementations, the one or more communication buses 304 include circuitry that interconnects and controls communications between system components. In some implementations, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more ER displays 312 are configured to display ER content to the user. In some implementations, the one or more ER displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more ER displays 312 correspond to diffractive, reflective, polarized, holographic, etc. waveguide displays. For example, the electronic device 120 includes a single ER display. In another example, the electronic device 120 includes an ER display for each eye of the user. In some implementations, the one or more ER displays 312 are capable of presenting MR and VR content.

In some implementations, the one or more image sensors 314 are configured to obtain image data that corresponds to at least a portion of the face of the user that includes the eyes of the user (any may be referred to as an eye-tracking camera). In some implementations, the one or more image sensors 314 are configured to be forward-facing so as to obtain image data that corresponds to the physical setting as would be viewed by the user if the electronic device 120 was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some implementations, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some implementations, the memory 320 or the non-transitory computer readable storage medium of the memory 320 stores the following programs, modules and data structures, or a subset thereof including an optional operating system 330 and an ER presentation module 340.

The operating system 330 includes procedures for handling various basic system services and for performing hardware dependent tasks. In some implementations, the ER presentation module 340 is configured to present ER content to the user via the one or more ER displays 312. To that end, in various implementations, the ER presentation module 340 includes a data obtaining unit 342, an ER presenting unit 344, an ER map generating unit 346, and a data transmitting unit 348.

In some implementations, the data obtaining unit 342 is configured to obtain data (e.g., presentation data, interaction data, sensor data, location data, etc.) from at least the controller 110. To that end, in various implementations, the data obtaining unit 342 includes instructions and/or logic therefor, and heuristics and metadata therefor.

In some implementations, the ER presenting unit 344 is configured to present ER content via the one or more ER displays 312. To that end, in various implementations, the ER presenting unit 344 includes instructions and/or logic therefor, and heuristics and metadata therefor.

In some implementations, the ER map generating unit 346 is configured to generate an ER map based on a plurality of images. To that end, in various implementations, the ER map generating unit 346 includes instructions and/or logic therefor, and heuristics and metadata therefor.

In some implementations, the data transmitting unit 348 is configured to transmit data (e.g., presentation data, location data, etc.) to at least the controller 110. To that end, in various implementations, the data transmitting unit 348 includes instructions and/or logic therefor, and heuristics and metadata therefor.

Although the data obtaining unit 342, the ER presenting unit 344, the ER map generating unit 346, and the data transmitting unit 348 are shown as residing on a single device (e.g., the electronic device 120), it should be understood that in other implementations, any combination of the data obtaining unit 342, the ER presenting unit 344, the ER map generating unit 346, and the data transmitting unit 348 may be located in separate computing devices.

Moreover, FIG. 3 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

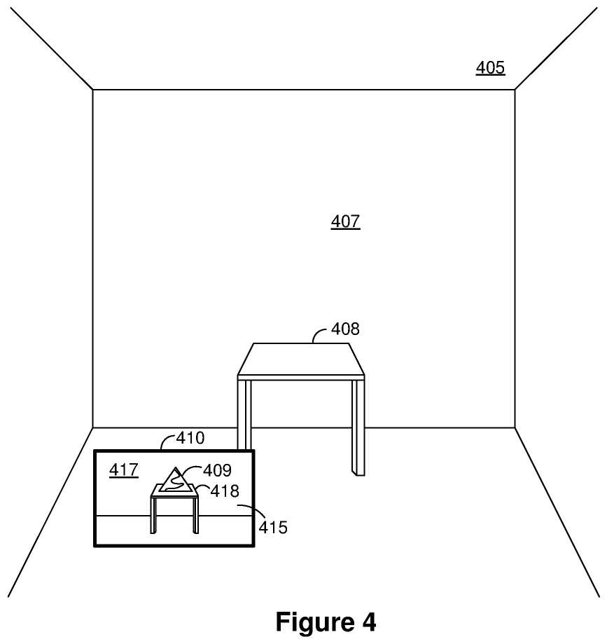

FIG. 4 illustrates a physical setting 405 with an electronic device 410 surveying the physical setting 405. The physical setting 405 includes a table 408 and a wall 407.

The electronic device 410 displays, on a display, a representation of the physical setting 415 including a representation of the table 418 and a representation of the wall 417. In various implementations, the representation of the physical setting 415 is generated based on an image of the physical setting captured with a scene camera of the electronic device 410 having a field-of-view directed toward the physical setting 405. The representation of the physical setting 415 further includes an ER map 409 displayed on the representation of the table 418.

As the electronic device 410 moves about the scene 405, the representation of the physical setting 415 changes in accordance with the change in perspective of the electronic device 410. Further, the ER map 409 correspondingly changes in accordance with the change in perspective of the electronic device 410. Accordingly, as the electronic device 410 moves, the ER map 409 appears in a fixed relationship with respect to the representation of the table 418.

In various implementations, the ER map 409 corresponds to a plurality of images associated with a first user. In various implementations, the plurality of images is stored in a non-transitory memory of a device of the first user, e.g., the first user's smartphone. In various implementations, the plurality of images is stored in a cloud database associated with an account of the first user, e.g., a social media account or a photo storage account. In various implementations, each of the plurality of images includes metadata identifying the first user, e.g., the first user is “tagged” in each of the plurality of images.

In various implementations, each of the plurality of images is further associated with a respective time and a respective location. In various implementations, at least one of the plurality of images is associated with metadata indicating a time and a place the image was taken. In various implementations, at least one of the plurality of images is associated with a time the image was posted to a social media website. In various implementations, at least one of the plurality of images is associated with metadata indicating a tagged location, e.g., a location selected by a user from a database of locations.

The respective time may be an exact time or a range of time. Thus, in various implementations, at least one of the respective times is a clock time (e.g., 4:00 pm on Mar. 20, 2005). In various implementations, at least one of the respective times is a date (e.g., Aug. 7, 2010). In various implementations, at least one of the respective times is a month (e.g., April 2012) or a year (e.g., 2014).

The respective location may be an exact location or a general location. Thus, in various implementations, at least one of the respective locations is defined by GPS coordinates. In various implementations, at least one of the respective locations is a building (e.g., the Empire State Building) or a park (e.g., Yellowstone National Park). In various implementations, at least one of the respective locations is a city (e.g., San Francisco) or a state (e.g., Hawaii).

Based on the plurality of images (and their respective times and respective locations), the electronic device 410 determines a plurality of a clusters associated with the first user. Each of the plurality of clusters represents a subset of the plurality of images. Various clustering algorithms can be used to determine the plurality of clusters and various factors can influence these algorithms.

In various implementations, a cluster is determined based on a number of images at a location of the plurality of image. In various implementations, a cluster is more likely to be determined when there are a greater number of the plurality of images at a location (or within a threshold distance from a location). As an example, if the plurality of images includes five images taken in Washington, D.C., the electronic device 410 defines a cluster associated with those five images. However, if the plurality of images includes only one image in Denver, the electronic device 410 does not define a cluster associated with that image. In various implementations, the five images are more likely to correspond to an important event of the first user (e.g., an educational field trip), whereas the one image is more likely to correspond to an unimportant event of the first user (e.g., taking a self-portrait at the airport).

In various implementations, a cluster is determined based on a time span of a number of images at a location of the plurality of images. In various implementations, a cluster is more likely to be determined when there is a set of the plurality of images at a location covering at least a threshold amount of time (which may be a function of the number of images). As an example, if the plurality of images includes four images taken at an amusement park in Florida over the course of three days (e.g., greater than a threshold of two days), the electronic device 410 defines a cluster associated with those four images. However, if the plurality of images includes four images taken at the amusement park in Florida within a twenty-minute window (e.g., less than a threshold of two days), the electronic device 410 does not define a cluster associated with those four images. In various implementations, the four images taken over the course of three days is more likely to correspond to an important event of the first user (e.g., a vacation to the amusement park), whereas the four images taken within a twenty-minute window is more likely to correspond to an unimportant event of the first user (e.g., driving by the amusement park).

In various implementations, a cluster is determined based on metadata regarding the first user, e.g., a home location. In various implementations, a cluster is more likely to be determined when there is a set of the plurality of images at a location far from the home location of the first user. As an example, assuming that the home location of the first user is within San Diego County, California, if the plurality of images includes six images taken in Zion National Park, in Utah, the electronic device 410 defines a cluster associated with those six images. However, if the plurality of images includes six images taken at the San Diego Zoo, within San Diego County, the electronic device 410 does not define a cluster associated with those six images. In various implementations, the six images taken far from the first user's home location is more likely to correspond to an important event of the first user (e.g., a hiking expedition), whereas the six images taken close to the first user's home location is more likely to correspond to an unimportant event of the first user (e.g., a weekend outing).

In various implementations, a cluster is determined based on additional metadata regarding at least one of the plurality of images. In various implementations, a cluster is more likely to be determined when there is a set of plurality images associated with a tagged event (either in the post including the image or within a threshold amount of time of such a post). For example, if the plurality of images includes four images posted to a social media website on the same day as post announcing an engagement, the electronic device 410 defines a cluster associated with those four images. However, if the plurality of images includes four images posted to a social media website on the same day without any event tagged, the electronic device 410 does not define a cluster associated with those four images. In various implementations, the four images associated with a tagged event are more likely to correspond to an important event of the first user (e.g., an engagement), whereas the four images not associated with a tagged event are more likely to correspond to an unimportant event of the first user (e.g., a particularly aesthetic meal).

Each of the plurality of clusters is associated with a respective cluster time defining a timeline of the plurality of clusters (and, for each of the plurality of clusters, a position in the timeline). Accordingly, the plurality of respective cluster times defines an order of the plurality of clusters.

Based on the plurality of clusters, the electronic device 410 obtains a plurality of ER setting representations. For example, for a cluster associated with an amusement park, the electronic device 410 obtains an ER setting representation of a prominent ride at the amusement park. As another example, for a cluster associated with Washington, D.C., the electronic device 410 obtains an ER setting representation of the White House. The electronic device 410 displays the ER setting representations within the ER map 409.

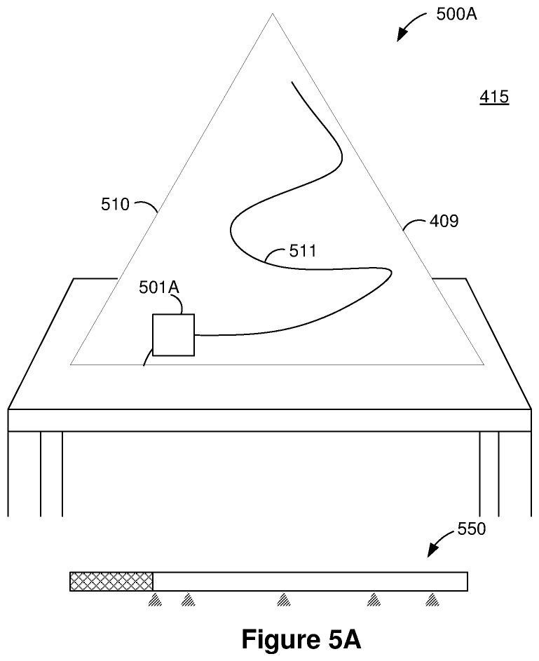

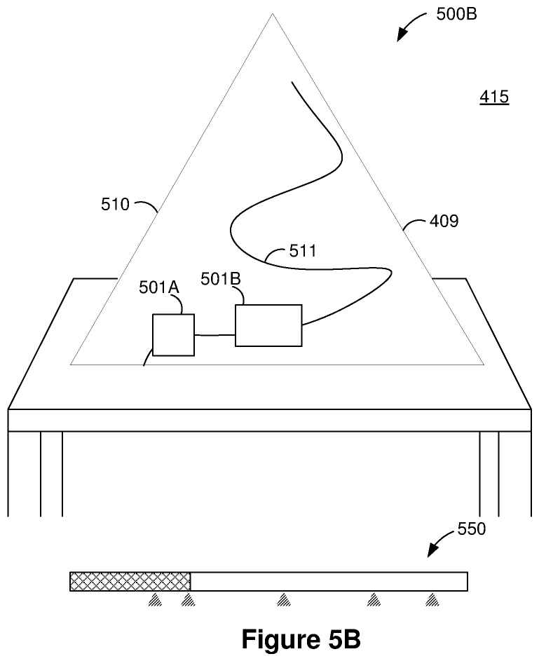

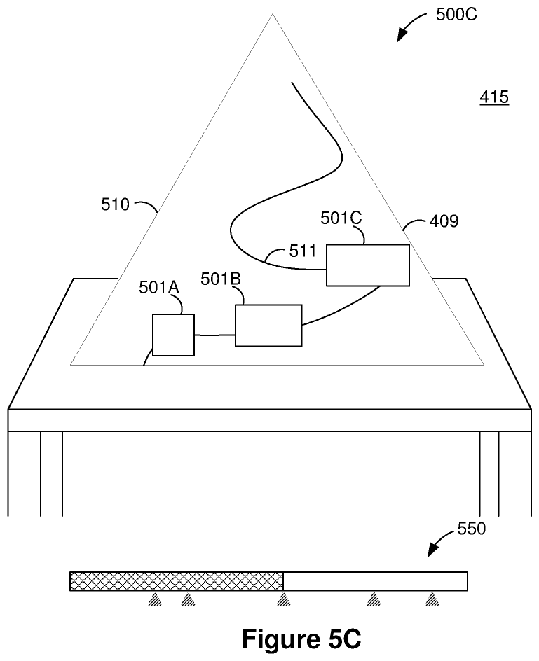

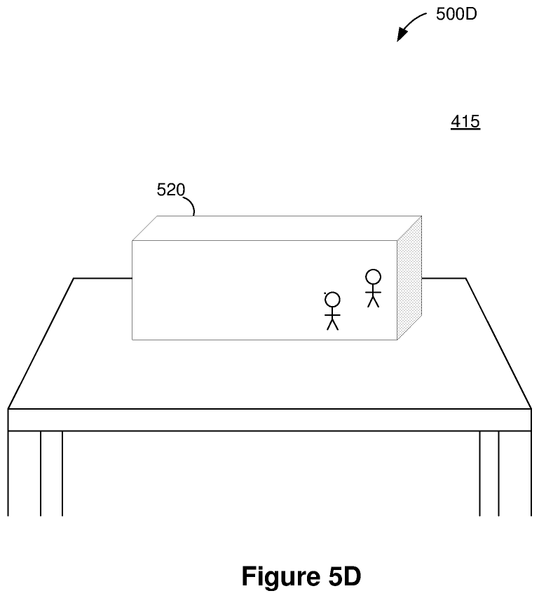

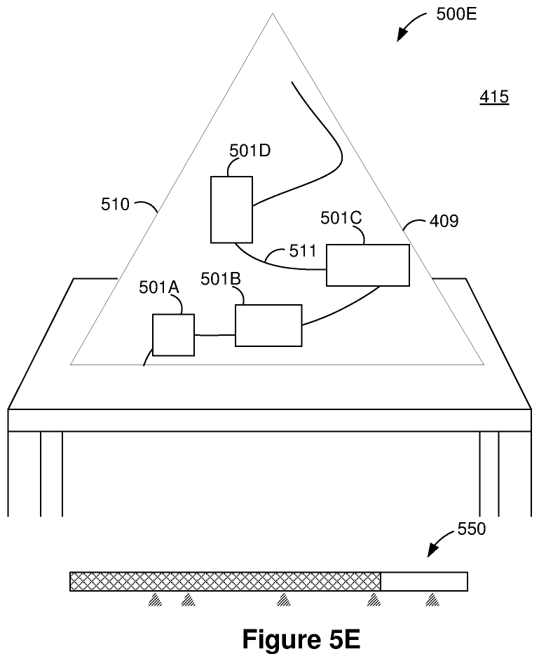

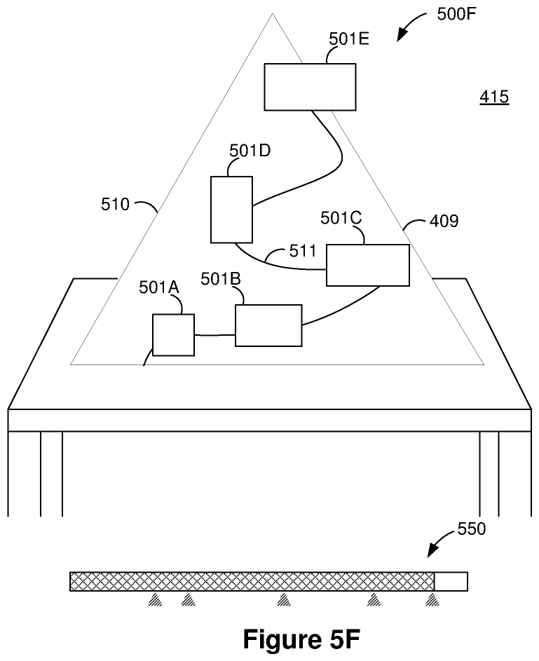

FIG. 5A illustrates a portion of the display of the electronic device 410 displaying, at a first time, a first image 500A of the representation of the physical setting 415 including the ER map 409. In various implementations, the first image 500A is displayed at a first time in the timeline, the first time corresponding to the respective cluster time of the first cluster. As an example, the first time corresponds to one minute after first displaying the ER map 409 that corresponds to a particular date, e.g., Mar. 1, 2010. In FIG. 5A, the electronic device 410 displays a timeline representation 550 indicating the current time in the timeline.

In FIG. 5A, the ER map 409 includes an ER map representation 510 (a representation of a mountain) with a path representation 511 (a representation of a footpath winding up the mountain). In various implementations, the ER map representation 510 is a default ER map representation or an ER map representation selected by a user. In various implementations, the ER map representation 510 is obtained based on the plurality of images. For example, in some implementations, the ER map representation 510 is selected from a plurality of stored ER map representations based on the plurality of images. For example, if each of the plurality of images is associated with a respective location within the United States, the ER map representation is a map of the United States.

The ER map 409 includes a first ER setting representation 501A (e.g., a representation of a house) displayed along the path representation 511. In various implementations, the first ER setting representation 501A is obtained based on a respective cluster location of the first cluster. For example, in some implementations, the first ER setting representation 501A is selected from a plurality of stored ER setting representations based on the respective cluster location of the first cluster. As another example, in some implementations, the first ER setting representation 501A is generated based on one or more of the plurality of images associated with the first cluster.

FIG. 5B illustrates a portion of the display of the electronic device 410 displaying, at a second time, a second image 500B of the representation of the physical setting 415 including the ER map 409. In various implementations, the second image 500B is displayed at a second time in the timeline, the second time corresponding to the respective cluster time of the second cluster. As an example, the second time corresponds to 90 seconds after first displaying the ER map 409 which corresponds to a particular date, e.g., Dec. 1, 2010. In FIG. 5B, the electronic device 410 displays the timeline representation 550 indicating the current time in the timeline.

As compared to FIG. 5A, the ER map 409 further includes a second ER setting representation 501B (e.g., a representation of a school) displayed further along the path representation 511. In various implementations, the second ER setting representation 501B is obtained in a similar manner to the first ER setting representation 501A.

FIG. 5C illustrates a portion of the display of the electronic device 410 displaying, at a third time, a third image 500C of the representation of the physical setting 415 including the ER map 409. In various implementations, the third image 500C is displayed at a third time in the timeline, the third time corresponding to the respective cluster time of the third cluster. As an example, the second time corresponds to two-and-a-half minutes after first displaying the ER map 409 which corresponds to a particular date, e.g., Dec. 1, 2011. In FIG. 5C, the electronic device 410 displays the timeline representation 550 indicating the current time in the timeline.

As compared to FIG. 5B, the ER map 409 further includes a third ER setting representation 501C (e.g., a representation of the Parthenon) displayed further along the path representation 511. In various implementations, the third ER setting representation 501C is obtained in a similar manner to the first ER setting representation 501A.

The third ER setting representation 501C is associated with a third affordance which, when selected, causes display of a third ER setting. Similarly, the first ER setting representation 501A is associated with a first affordance which, when selected, causes display of a first ER setting and the second ER setting representation 501B is associated with a second affordance which, when selected, causes display of a second ER setting.

FIG. 5D illustrates a portion of the display of the electronic device 410 displaying, at a fourth time and in response to detecting selection of the third affordance, a fourth image 500D of the representation of the physical setting 415 including a third ER setting 520. In various implementations, the third ER setting 520 is obtained in a similar manner to the third ER setting representation 501C.

In various implementations, the third ER setting 520 includes a representation of a location and further includes virtual objects corresponding to the plurality of images. For example, in some implementations, the third ER setting 520 is populated with virtual objects corresponding to the plurality of images associated with the third cluster, for example, based on one or more images of people or objects in the plurality of images associated with the third cluster.

In various implementations, in response to detecting selection of the third affordance, the ER map 409 ceases to be displayed. In various implementations, in response to detecting selection of the third affordance, progression through the timeline ceases. However, in various implementations, in response to detecting selection of the third affordance, progression through the timeline continues.

In response to a user selection to return to the ER map 409, either via a gesture or selection of a back affordance in the third ER setting, the third ER setting ceases to be displayed (and, if hidden, the ER map 409 is redisplayed).

FIG. 5E illustrates a portion of the display of the electronic device 410 displaying, at a fifth time, a fifth image 500E of the representation of the physical setting 415 including the ER map 409. In various implementations, the fifth image 500E is displayed at a fourth time in the timeline, the fourth time corresponding to the respective cluster time of the fourth cluster. As an example, the fourth time corresponds to four minutes after first displaying the ER map 409 which corresponds to a particular date, e.g., Mar. 1, 2012. In FIG. 5E, the electronic device 410 displays the timeline representation 550 indicating the current time in the timeline.

As compared to FIG. 5C, the ER map 409 further includes a fourth ER setting representation 501D (e.g., a representation of a skyscraper) displayed further along the path representation 511. In various implementations, the fourth ER setting representation 501D is obtained in a similar manner to the first ER setting representation 501A.

FIG. 5F illustrates a portion of the display of the electronic device 410 displaying, at a sixth time, a sixth image 500F of the representation of the physical setting 415 including the ER map 409. In various implementations, the sixth image 500F is displayed at a fifth time in the timeline, the fifth time corresponding to the respective cluster time of the fifth cluster. As an example, the fifth time corresponds to five minutes after first displaying the ER map 409 which corresponds to a particular date, e.g., Mar. 1, 2013. In FIG. 5F, the electronic device 410 displays the timeline representation 550 indicating the current time in the timeline.

As compared to FIG. 5E, the ER map 409 further includes a fifth ER setting representation 501E (e.g., a representation of the Capitol Building) displayed further along the path representation 511. In various implementations, the fifth ER setting representation 501E is obtained in a similar manner to the first ER setting representation 501A.

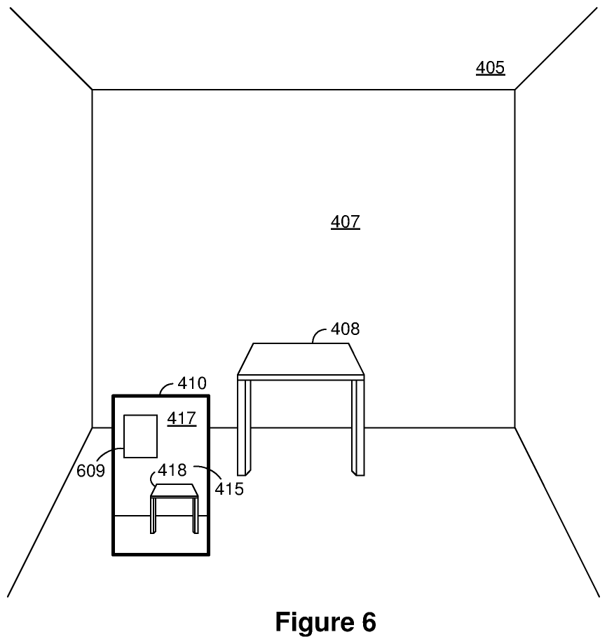

FIG. 6 illustrates the physical setting 405 of FIG. 4 with the electronic device 410 surveying the physical setting 405. As noted above, the physical setting 405 includes a table 408 and a wall 407.

In FIG. 6, the electronic device 410 displays, on a display, a representation of the physical setting 415 including a representation of the table 418 and a representation of the wall 417. In various implementations, the representation of the physical setting 415 is generated based on an image of the physical setting captured with a scene camera of the electronic device 410 having a field-of-view directed toward the physical setting 405. The representation of the physical setting 415 further includes an ER map 609 displayed on the representation of the wall 417.

As the electronic device 410 moves about the physical setting 405, the representation of the physical setting 415 changes in accordance with the change in perspective of the electronic device 410. Further, the ER map 609 correspondingly changes in accordance with the change in perspective of the electronic device 410. Accordingly, as the electronic device 410 moves, the ER map 609 appears in a fixed relationship with respect to the representation of the wall 417.

Like the ER map 409 of FIG. 4, in various implementations, the ER map 609 corresponds to a plurality of images associated with a first user. However, the CGR map ER also corresponds to a plurality of images associated with a second user.

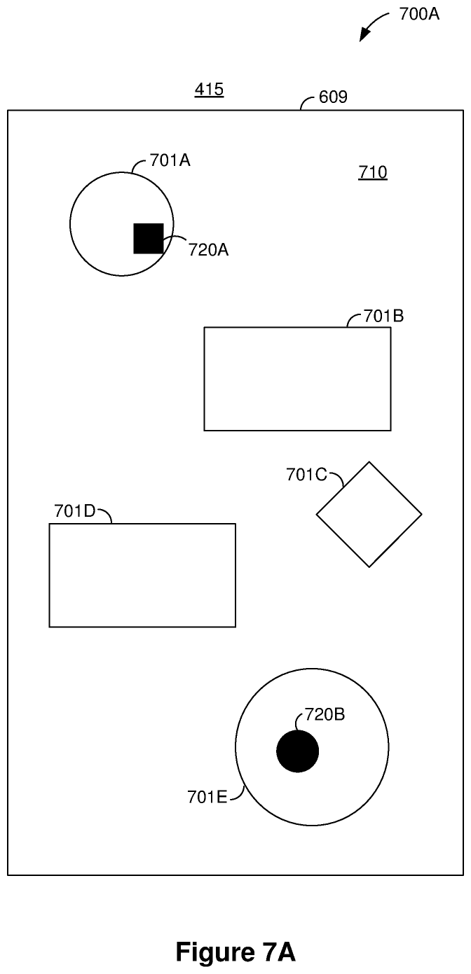

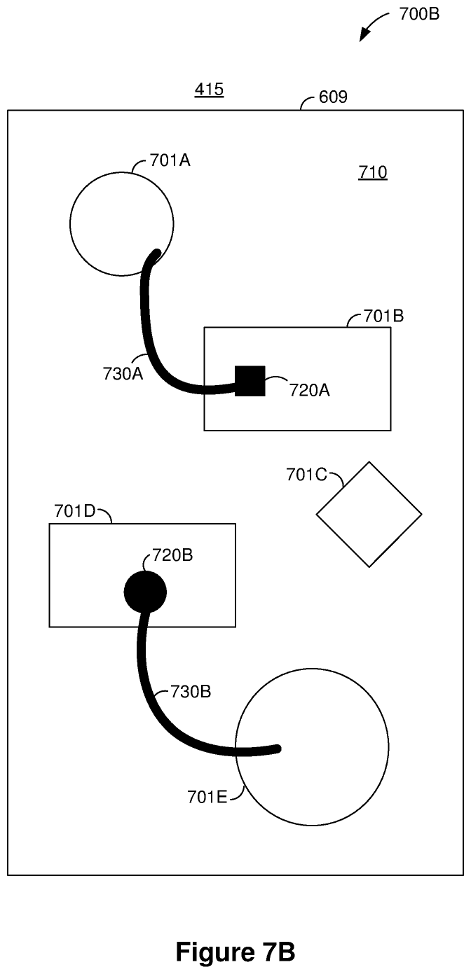

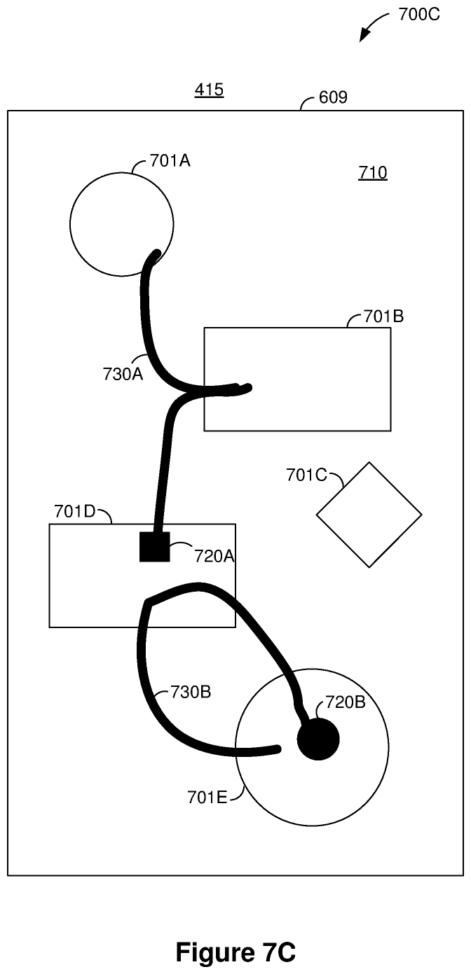

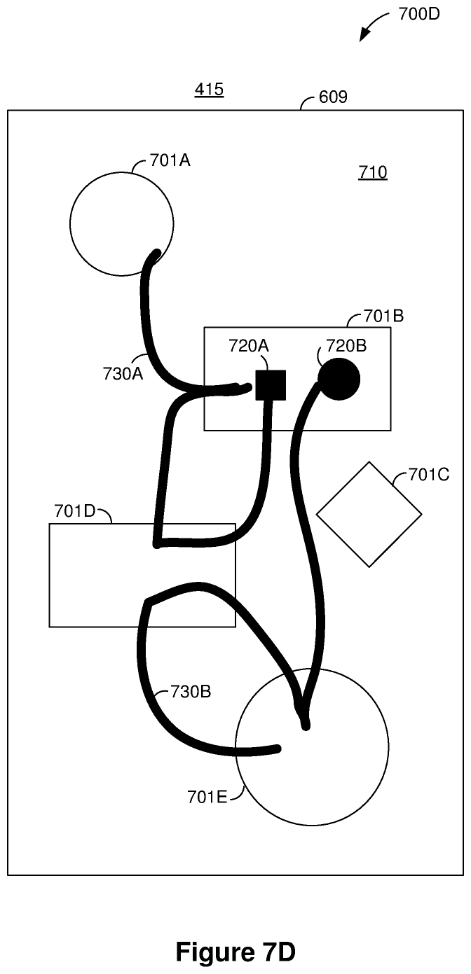

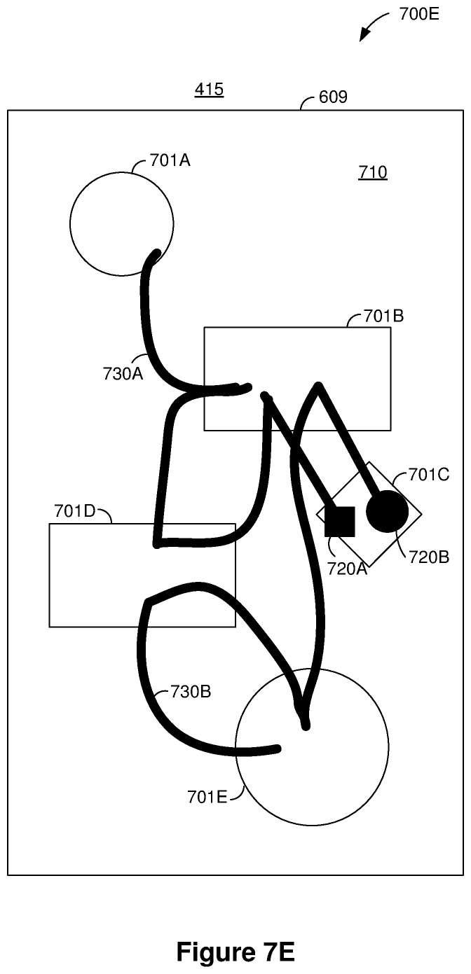

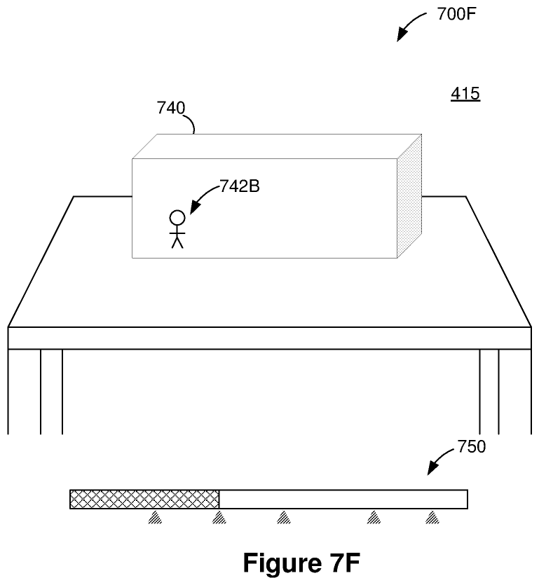

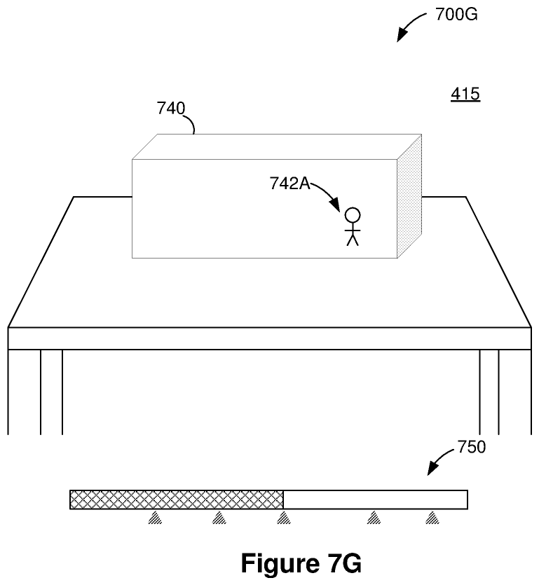

FIG. 7A illustrates a portion of the display of the electronic device 410 displaying, at a first time, a first image 700A of the representation of the physical setting 415 including the ER map 609.

In FIG. 7A, the ER map 609 includes an ER map representation 710 (a representation of a paper map). In various implementations, the ER map representation 710 is a default ER map representation or an ER map representation selected by a user. In various implementations, the ER map representation 710 is obtained based on the plurality of images associated with the first user and the plurality of images associated with the second user. For example, in some implementations, the ER map representation 710 is selected from a plurality of stored ER map representations based on the plurality of images associated with the first user and the plurality of images associated with the second user.

Whereas, at the first time illustrated in FIG. 5A, the ER map 409 includes only the first ER setting representation 501A, at the first time illustrated in FIG. 7A, the ER map 609 includes a plurality of ER setting representations 701A-701E. The plurality of ER setting representations 701A-701E includes a first ER setting representation 701A, a second ER setting representation 701B, a third ER setting representation 701C, a fourth ER setting representation 701D, and a fifth ER setting representation 701E. At least one of the plurality of ER setting representations 701A-701E is associated with an affordance which, when selected, causes display of a respective ER setting. In some implementations, each of the plurality of ER setting representations is associated with an affordance which, when selected, causes display of a respective ER setting.

In various implementations, each of the plurality of ER setting representations 701A-701E is obtained in a similar manner to the first ER setting representation 501A of FIG. 5A.

For example, the electronic device 410 determines a plurality of first clusters associated with the first user and a plurality of respective first cluster times and plurality of respective first cluster locations. The electronic device 410 further determines a plurality of second clusters associated with the second user and a plurality of respective second cluster times and a plurality of respective second cluster locations.

The electronic device 410 obtains a plurality of ER setting representations based on the plurality of respective first cluster locations and the plurality of respective second cluster locations. At least one of the plurality of respective first cluster locations is the same as one of the plurality of respective second cluster locations. Thus, a single ER setting representation is obtained to represent both respective cluster locations in the ER map 609.

The ER map 609 includes a first object representation 720A displayed at the location of the first ER setting representation 701A and a second object representation 720B displayed at the location of the fifth ER setting representation 701E. In various implementations, the first object representation 720A represents the first user. In various implementations, the first object representation 720A is obtained based on the plurality of images associated with the first user. Similarly, the second object representation 720B represents the second user. In various implementations, the second object representation 720A is obtained based on the plurality of images associated with the second user.

FIG. 7B illustrates a portion of the display of the electronic device 410 displaying, at a second time, a second image 700B of the representation of the physical setting 415 including the ER map 609.

In FIG. 7B, the first object representation 720A is displayed at the location of the second ER setting representation 701B and the second object representation 720B is displayed at the location of the fourth ER setting representation 701D. Further, the ER map 609 includes a first path representation 730A between the first ER setting representation 701A and the second ER setting representation 701B indicating that the first object representation 720A has moved from the first ER setting representation 701A to the second ER setting representation 701B. The ER map 609 includes a second path representation 730B between the fifth ER setting representation 701E and the fourth ER setting representation 701D indicating that the second object representation 720B has moved from the fifth ER setting representation 701E to the fourth ER setting representation 701D.

FIG. 7C illustrates a portion of the display of the electronic device 410 displaying, at a third time, a third image 700C of the representation of the physical setting 415 including the ER map 609.

In FIG. 7C, the first object representation 720A is displayed at the location of the fourth ER setting representation 701D and the second object representation 720B is displayed at the location of the fifth ER setting representation 701E. Further, the first path representation 730A is extended to include a portion between the second ER setting representation 701B and the fourth ER setting representation 701D indicating that the first object representation 720A has moved from the second ER setting representation 701B to the fourth ER setting representation 701D. The second path representation 730B is extended to include a portion between the fourth ER setting representation 701D and the fifth ER setting representation 701E indicating that the second object representation 720B has moved from the fourth ER setting representation 701D to the fifth ER setting representation 701E.

FIG. 7D illustrates a portion of the display of the electronic device 410 displaying, at a fourth time, a fourth image 700D of the representation of the physical setting 415 including the ER map 609.

In FIG. 7D, the first object representation 720A is displayed at the location of the second ER setting representation 701B and the second object representation 720B is also displayed at the location of the second ER setting representation 701B. Further, the first path representation 730A is extended to include a portion between the fourth ER setting representation 701D and the second ER setting representation 701B indicating that the first object representation 720A has moved from the fourth ER setting representation 701D to the second ER setting representation 701B. The second path representation 730B is extended to include a portion between the fifth ER setting representation 701E and the second ER setting representation 701B indicating that the second object representation 720B has moved from the fifth ER setting representation 701E to the second ER setting representation 701B.

FIG. 7E illustrates a portion of the display of the electronic device 410 displaying, at a fifth time, a fifth image 700E of the representation of the physical setting 415 including the ER map 609.

In FIG. 7E, the first object representation 720A is displayed at the location of the third ER setting representation 701C and the second object representation 720B is also displayed at the location of the third ER setting representation 701C. Further, the first path representation 730A is extended to include a portion between the second ER setting representation 701B and the third ER setting representation 701C indicating that the first object representation 720A has moved from the second ER setting representation 701B to the third ER setting representation 701C. The second path representation 730B is extended to include a portion between the second ER setting representation 701B and the third ER setting representation 701C indicating that the second object representation 720B has also moved from the second ER setting representation 701B to the third ER setting representation 701C.

As an illustrative example, FIGS. 7A-7E correspond to an ER map associated with images of a husband and wife. A device selects an ER map representation 409 of a paper map as a default ER map representation. At a first time, the plurality of images associated with the husband includes a first cluster associated with a birthday party in the husband's hometown of North Carolina and the plurality of images associated with the wife includes a second cluster associated with a homecoming game in the wife's hometown of Texas. The device determines a location for the first cluster as South Dakota and selects the first ER setting representation 701A as Mount Rushmore (a landmark in South Dakota). The device associates the first object representation 720A with the first ER setting representation 701A and the first time. Similarly, the device determines a location of the second cluster of the wife's high school, selects the fifth ER setting representation 701E of a generic high school building (the particular high school being unavailable), and associates the second object representation 720B with the fifth ER setting representation 701E and the first time.

At a second time, the plurality of images associated with the husband includes a third cluster associated with a vacation to Hawaii and the plurality of images associated with the wife includes a fourth cluster associated with graduation from UC San Diego. The device determines a location for the third cluster as Hawaii and selects the second ER setting representation 701B as the USS Arizona (a memorial in Hawaii). The device associates the first object representation 720A with the second ER setting representation 701B and the second time. Similarly, the device determines a location of the second cluster as UC San Diego, selects the fourth ER setting representation 701D of the Geisel Library Building (a prominent and representative building at UC San Diego), and associates the second object representation 720B with the fourth ER setting representation 701D and the second time.

At a third time, the plurality of images associated with the husband includes a fifth cluster associated with a visit to Birch Aquarium (located at UC San Diego) and the plurality of images associated with the wife includes a sixth cluster associated with the wife's first week teaching at the wife's high school in Texas. The device determines a location for the fifth cluster as UC San Diego and associates the first object representation 720A with the fourth CGR environment representation 701D and the third time. Similarly, the device determines a location of the sixth cluster as the wife's high school and associates the second object representation 720B with the fifth ER setting representation 701E and the third time.

At a fourth time, the plurality of images associated with the husband includes a seventh cluster associated with a second vacation in Hawaii and the plurality of images associated with the wife includes an eighth cluster associated with a teachers' conference also in Hawaii. The device determines a location for the seventh cluster as Hawaii and associates the first object representation 720A with the second ER setting representation 701B and the fourth time. Similarly, the device determines a location for the eighth cluster as Hawaii and associates the second object representation 720B with the second ER setting representation 701B and the fourth time.

At a fifth time, the plurality of images associated with the husband includes a ninth cluster associated with the husband and wife's wedding in Yosemite National Park and the plurality of images associated with the wife includes a tenth cluster also associated with the wedding in Yosemite National Park. The device determines a location for the seventh cluster and the eighth cluster as Yosemite National Park and selects the third ER setting representation 701C as El Capitan (a natural landmark in Yosemite National Park). The device associates the first object representation 720A and the second object representation 720B with the third ER setting representation 701C and the fifth time.

FIG. 7F illustrates a portion of the display of the electronic device 410 displaying, at a sixth time and in response to detecting selection of the fourth affordance, a sixth image 700F of the representation of the scene 415 including the fourth ER setting 740. In various implementations, the fourth ER setting 740 is obtained in a similar manner to the third ER setting 520 of FIG. 5D.

In various implementations, the fourth ER setting 740 includes a representation of a location at a particular time (e.g., the second time as indicated by the timeline indicator 750) and further includes virtual objects corresponding to the plurality of images associated with the fourth ER setting representation 701D and the second time (e.g., the fourth cluster). For example, in some implementations, the fourth ER setting 740 is populated with virtual objects corresponding to the plurality of images associated with the fourth cluster, for example, based on one or more images of people or objects in the plurality of images associated with the fourth cluster. For example, in FIG. 7F, the fourth ER setting 740 includes virtual object representing the second user 742B.

In various implementations, in response to detecting selection of the fourth affordance, the ER map 609 ceases to be displayed. In various implementations, in response to detecting selection of the fourth affordance, progression through the timeline ceases. However, in various implementations, in response to detecting selection of the fourth affordance, progression through the timeline continues.

FIG. 7G illustrates a portion of the display of the electronic device 410 displaying, at a seventh time and in response to a change in the timeline, a seventh image 700G of the representation of the scene 415 including the fourth ER setting 740.

In various implementations, the fourth ER setting 740 includes a representation of a location at a particular time (e.g., the third time as indicated by the timeline indicator 750) and further includes virtual objects corresponding to the plurality of images associated with the fourth ER setting representation 701D and the third time (e.g., the fifth cluster). For example, in some implementations, the fourth ER setting 740 is populated with virtual objects corresponding to the plurality of images associated with the fifth cluster, for example, based on one or more images of people or objects in the plurality of images associated with the fifth cluster. For example, in FIG. 7G, the fourth ER setting 740 includes virtual object representing the first user 742A.

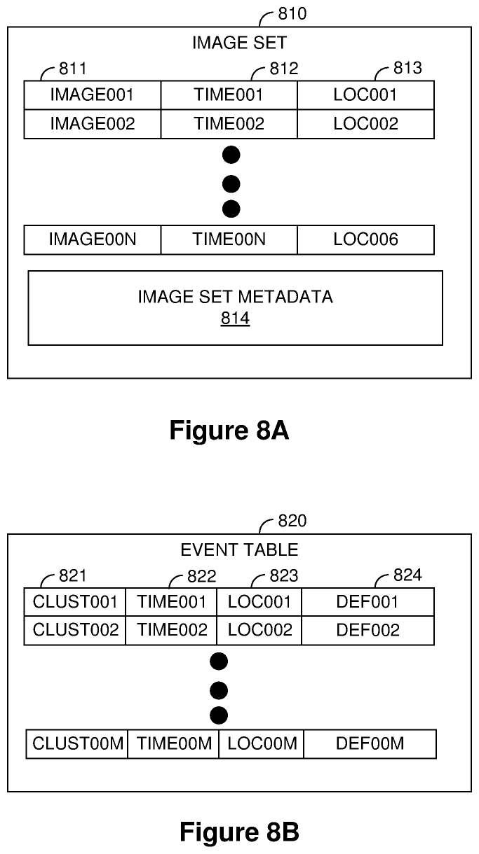

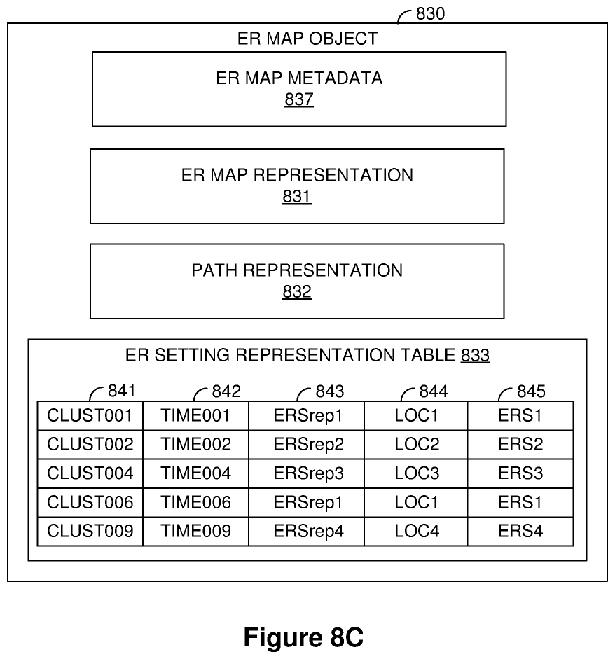

FIG. 8A illustrates an image set 810 in accordance with some implementations. The image set 810 includes a plurality of images each including image data 811, respective time data 812 indicative of a respective time of the image in the image set 810, and respective location data 813 indicative of a respective location of the image in the image set 810.

The image set 810 further includes image set metadata 814. In various implementations, the image set metadata 814 includes data indicative of a first user. In various implementations, the image set metadata 814 includes data indicative of the source of the image set 810 or when the image set 810 was compiled.

In various implementations, a device determines, from the image set, a plurality of clusters. In some implementations, the plurality of clusters is stored as a cluster table.

FIG. 8B illustrates a cluster table 820 in accordance with some implementations. The cluster table 820 includes a plurality of entries respectively associated with a plurality of clusters. Each entry includes a cluster identifier 821 of the cluster, a cluster time 822, a cluster location 823, and a cluster definition 824 of the cluster.

In various implementations, the cluster identifier 821 is a unique name or number of the cluster. In various implementations, the cluster definition 823 indicates which of the plurality of images of the image set are associated with the cluster.

In various implementations, a device generates an ER map object based, in part, on the cluster table 820.

FIG. 8C illustrates an ER map object 830 in accordance with some implementations. The ER map object 830 includes an ER map metadata field 837 including metadata for the ER map object 830. In various implementations, the metadata indicates the image set 810 to which the ER map corresponds. In various implementations, the metadata indicates a date and/or time the ER map object 830 was created and/or modified.

The ER map object 830 includes an ER map representation field 831 including data indicative of an ER map representation. In various implementations, the ER map representation field 831 includes an ER map representation, such as the ER map representation 510 of FIG. 5A or the ER map representation 710 of FIG. 7A. In various implementations, the ER map representation field 831 includes a reference to an ER map representation that is stored separate from the ER map object 830, either locally with the ER map object 830 or remotely on another device, such as a network server.

The ER map object 830 includes a path representation field 832 including data indicative of a path. The path includes a set of ordered locations (e.g., with reference to the ER map representation or an ER coordinate space). In various implementations, the number of ordered locations is more (e.g., ten times or a hundred times) than the number of entries in the cluster table 820.

The ER map object 830 includes an ER setting representation table 833 including a plurality of entries, each entry corresponding to one of the entries of the cluster table 820. In various implementations, the number of entries of the ER setting representation table 833 is less than the number of entries of the cluster table 820. For example, in various implementations, no entry in the ER setting representation table 833 corresponds to a particular entry of the cluster table 820 (e.g., if a suitable ER setting representation can be found).

Each entry of the ER setting representation table 833 includes the cluster identifier 841 of the corresponding entry of the cluster table 820 and the cluster time 842 of the corresponding entry of the cluster table 820. Each entry of the ER setting representation table 833 includes an ER setting representation field 843 including data indicative of an ER setting representation. In various implementations, the ER setting representation field 843 includes an ER setting representation, such as the ER setting representations 501A-501E of FIG. 5F or the ER setting representations 710A-710E of FIG. 7A. In various implementations, the ER setting representation field 843 includes a reference to an ER setting representation that is stored separately from the ER map object 830, either locally with the ER map object 830 or remotely on another device, such as a network server.

Each entry of the ER setting representation table 833 includes an ER setting representation location field 844 including data indicating the location of the ER setting representation (e.g., with reference to the ER map representation or an ER coordinate space). Because the ER setting representations are located along the path, each location in the ER setting representation location fields 844 is a location of the set of ordered locations of the path indicated by the path representation field 832.

Each entry of the ER setting representation table 833 includes an ER setting field 845 including data indicative of an ER setting corresponding to the ER setting representation. In various implementations, the ER setting field 843 includes an ER setting, such as the ER setting 520 of FIG. 5D. In various implementations, the ER setting field 843 includes a reference to an ER setting that is stored separate from the ER map object 830, either locally with the ER map object 830 or remotely on another device, such as a network server.

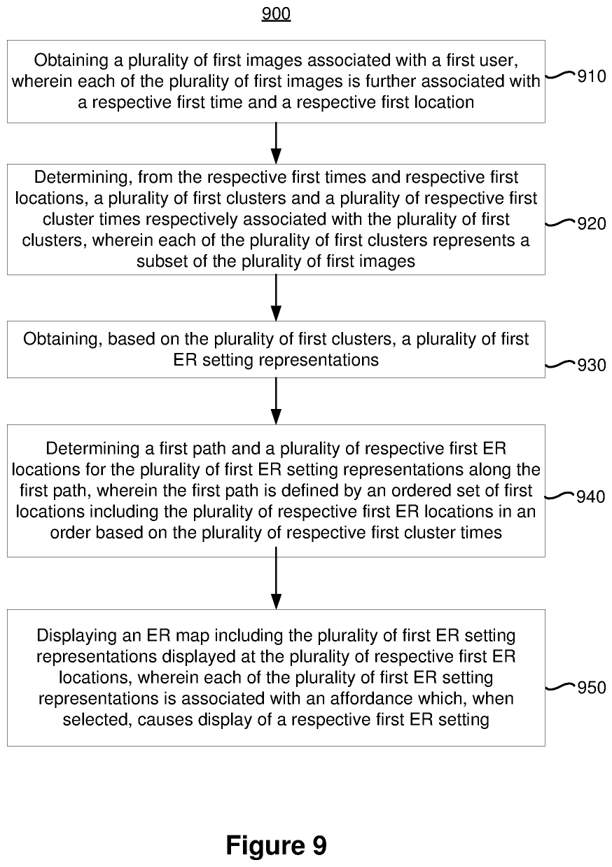

FIG. 9 is a flowchart representation of a method 900 of generating an ER map in accordance with some implementations. In various implementations, the method 900 is performed by a device with one or more processors and non-transitory memory (e.g., the electronic device 120 of FIG. 3 or electronic device 410 of FIG. 4). In some implementations, the method 900 is performed by processing logic, including hardware, firmware, software, or a combination thereof. In some implementations, the method 900 is performed by a processor executing instructions (e.g., code) stored in a non-transitory computer-readable medium (e.g., a memory).

The method 900 begins, in block 910, with the device obtaining a plurality of first images associated with a first user, wherein each of the plurality of first images is further associated with a respective first time and a respective first location.

In various implementations, obtaining the plurality of first images associated with the first user includes receiving a user input from the first user to access a photo storage associated with the first user. In various implementations, obtaining the plurality of first images associated with the first user includes receiving permission and/or authentication credentials from the first user to access the photo storage associated with the first user. In various implementations, the photo storage is a local memory, e.g., a non-transitory computer-readable medium of the device. In various implementations, the photo storage is a remote memory, e.g., cloud storage.

In various implementations, obtaining the plurality of first images associated with the first user includes receiving a user input from the first user to access a social media account associated with the first user. In various implementations, obtaining the plurality of first images associated with the first user includes receiving permission and/or authentication credentials from the first user to access the social media account associated with the first user.

The method 900 continues, in block 920, with the device determining, from the respective first times and respective first locations, a plurality of first clusters and a plurality of respective first cluster times respectively associated with the plurality of first clusters, wherein each of the plurality of first clusters represents a subset of the plurality of first images. In various implementations, at least one of the first clusters further includes (or is associated with) audio and/or video content. In various implementations, at least one of the plurality of first clusters is manually determined by a user.

In various implementations, at least one of the plurality of first clusters is determined based on a number of images of the plurality of first images at a particular location. In various implementations, a cluster is more likely to be determined when there are a greater number of the plurality of first images at a location (or within a threshold distance from a location).

In various implementations, at least one of the plurality of first clusters is determined based on a time span of a number of images of the plurality of first images at a particular location. In various implementations, a cluster is more likely to be determined when there is a set of the plurality of first images at a location covering at least a threshold amount of time.

In various implementations, at least one of the plurality of first clusters is determined based on metadata regarding the first user. In various implementations, the metadata regarding the first user includes a home location. In various implementations, a cluster is more likely to be determined when there is a set of the plurality of first images at a location far from the home location of the first user.

In various implementations, at least one of the plurality of first clusters is determined based on a tagged event associated with a subset of the plurality of first images. In various implementations, a cluster is more likely to be determined when there is a set of the plurality of first images associated with a tagged event (either in the post including the image or within a threshold amount of time of such a post).

The method 900 continues, in block 930, with the device obtaining, based on the plurality of first clusters, a plurality of first ER setting representations. In various implementations, obtaining a particular first ER setting representation of the plurality of first ER setting representations includes selecting the particular first ER setting representation from a plurality of stored ER setting representations based on a respective cluster location of a corresponding cluster of the plurality of first clusters. In various implementations, the number of first ER setting representations is less than the number of first clusters.

The method 900 continues, in block 940, with the device determining a first path and a plurality of respective first ER locations for the plurality of first ER setting representations along the first path, wherein the first path is defined by an ordered set of first locations including the plurality of respective first ER locations in an order based on the plurality of respective first cluster times.

The method 900 continues, at block 940, with the device determining a path and a plurality of respective locations for the plurality of ER setting representations, wherein the path is defined by an ordered set of locations including the plurality of respective locations in an order based on the plurality of respective event times.

In various implementations, as an example, the path includes, in order, a start location, a first location, a second location, a third location, and an end location. In some implementations, the path includes a plurality of locations between the start location and the first location, a plurality of locations between the first location and the second location, a plurality of locations between the second location and the third location, and/or a plurality of locations between the third location and end location. Accordingly, the second location is further along the path than the first location and the third location is further along the path than the second location.

The plurality of respective first cluster times includes a first cluster time associated with a first cluster associated with a first ER setting representation, a second cluster time (later than the first cluster time) associated with a second ER setting representation, and a third cluster time (later than the second cluster time) associated with a third ER setting representation.

In various implementations, determining the first path and the plurality of respective first ER locations includes determining the first path and determining the plurality of respective first ER locations after determining the first path. For example, in various implementations, the device obtains an ER map representation (e.g., the ER map representation 510 of FIG. 5A), which includes a predefined path (e.g., corresponding to path representation 511). After obtaining the predefined path, the device determines the plurality of respective first ER locations as locations of the first path.

Further to the example above, the device selects a location of the first path (e.g., the first location) as the first respective location of the first ER setting representation, selects a location further along the path (e.g., the second location) as the second respective ER location of the second ER setting representation because the second ER setting representation is associated with a later cluster time than the first ER setting representation, and selects a location even further along the path (e.g., the third location) as the third respective ER location of the third CGR environment representation because the third ER setting representation is associated with a later time than the second ER setting representation. In various implementations, the distance along the path is proportional to the amount of time between the start of a timeline and the respective cluster time.

In various implementations, determining the first path and the plurality of respective first ER locations includes determining the plurality of respective first ER locations and determining the first path after determining the plurality of respective first ER locations. For example, in various implementations, the device obtains an ER map representation (e.g., the ER map representation 710 of FIG. 7A) and determines the plurality of respective first ER locations. In some implementations, the ER map representation includes predefined candidate locations and the device selects the plurality of respective first ER locations from the predefined candidate locations. In some implementations, the device determines the plurality of respective first ER locations randomly. In some implementations, the device determines the plurality of respective first ER locations according to a space-packing algorithm. After obtaining the plurality of respective first ER locations, the device determines the path through the plurality of respective first ER locations in an order based on the plurality of respective first cluster times.

Further to the example above, the device determines the first location of the path as the location of the first ER setting representation, determines the second location of the path as the location of the second ER setting representation because the second ER setting representation is associated with a later time than the first ER setting representation, and determines the third location of the path as the location of the third ER setting representation because the third ER setting representation is associated with a later time than the second ER setting representation.

In various implementations, the first path returns to the same location at different points along the first path. For example, in FIG. 7E, the first path representation 730A passes through the location of the second ER setting representation 701B twice. Accordingly, in various implementations, the path is defined by a set of ordered locations that include the same location two or more times. For example, in various implementations, the path includes, in order, a first location of a first ER setting representation associated with a first event time, a second location of a second ER setting representation associated with a second event time later than the first event time, and a third location the same as the first location because the first ER setting representation is further associated with a third event time later than the second event time. For example, a first event definition is associated with the first event time and the first ER setting representation and a third event definition is associated with the third event time and, also, the first ER setting representation.

In various implementations, determining the first path and the plurality of respective first ER locations includes determining the first path and the plurality of respective first ER locations simultaneously (e.g., iteratively choosing the first path and the plurality of respective first ER locations).

The method 900 continues, at block 950, with the device displaying an ER map including the plurality of first ER setting representations displayed at the plurality of respective first ER locations, wherein each of the plurality of first ER setting representations is associated with an affordance which, when selected, causes display of a respective first ER setting.

For example, in FIG. 5F, the electronic device 410 displays an ER map 409 including the plurality of ER setting representations 501A-501E displayed at the plurality of respective locations. Further, each of the plurality of ER setting representations is associated with an affordance when, when selected, causes display of a respective ER setting (e.g., the ER setting 520 of FIG. 5C). As another example, in FIG. 7E, the electronic device 410 displays an ER map 609 including the plurality of ER setting representations 701A-701E displayed at the plurality of respective locations.

In various implementations, displaying the ER map includes displaying a path representation of the first path. In some implementations, the path representation is embedded in the ER map representation.

In various implementations, displaying the ER map includes generating the ER map. For example, in various implementations, the device generates an ER map object, such as the ER map object 830 of FIG. 8C. In various implementations, the device generates an ER map rendering (e.g., an image or overlay) that can be displayed on a display.

In various implementations, the method 900 further includes obtaining a plurality of second images associated with a second user, wherein each of the plurality of second images is further associated with a respective second time and a respective second location. The method 900 further includes determining, from the respective second times and respective second locations, a plurality of second clusters and a plurality of respective second cluster times respectively associated with the plurality of second clusters, wherein each of the plurality of first clusters represents a subset of the plurality of second images. The method 900 further includes obtaining, based on the plurality of second clusters, a plurality of second ER setting representations. The method 900 further includes determining a second path and a plurality of respective second ER locations for the plurality of second ER setting representations along the second path, wherein the second path is defined by an ordered set of second locations including the plurality of respective second ER locations in an order based on the plurality of respective second cluster times. In various implementations, the ER map includes the plurality of second ER setting representations displayed at the plurality of respective second ER locations, wherein each of the plurality of second ER setting representations is associated with an affordance which, when selected, causes display of a respective second ER setting.

For example, in FIGS. 7A-7E, the ER map 609 includes a plurality of first ER setting representations based on images associated with a first user (e.g., the first ER setting representation 701A, the second ER setting representation 701B, the third ER setting representation 701C, and the fourth ER setting representation 701D) and a plurality of second ER setting representations based on images associated with a second user (e.g., the second ER setting representation 701B, the third ER setting representation 701C, the fourth ER setting representation 701D, and the fifth ER setting representation 701E).

In various implementations, the ordered set of second locations further includes one of the respective first ER locations within the order based on the plurality of respective second cluster times. For example, in FIGS. 7A-7E, the second path traverses some of the same locations as the first path.

In various implementations, the method 900 includes receiving user input indicative of a selection of an associated affordance of the one of the plurality of first ER setting representations at the one of the respective first ER locations and, in response to receiving the user input, displaying the corresponding ER setting. For example, in FIG. 7F, in response to receiving a user input selecting an affordance associated with the fourth ER setting representation 701D, the fourth ER setting 740 is displayed.

In various implementations, displaying the corresponding ER setting includes, in accordance with a determination that displaying the corresponding ER setting is associated with a first time, displaying at least one virtual object based on the first plurality of images and, in accordance with a determination that displaying the corresponding ER setting is associated with a second time, displaying at least one virtual object based on the second plurality of images. For example, in FIG. 7F, in accordance with a determination that displaying the fourth ER setting 740 is associated with the second cluster time, the fourth ER setting 740 includes the representation of the second user 742B and, in FIG. 7G, in accordance with a determination that displaying the fourth ER setting 740 is associated with the third cluster time, the fourth CGR environment 740 includes the representation of the first user 742A.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

1-21. (canceled)

22. A method comprising:
at an electronic device including a processor and non-transitory memory:
obtaining a plurality of first images associated with a first user, wherein each of the plurality of first images is further associated with a respective first time and a respective first location;
determining, from the respective first times and respective first locations, a plurality of first clusters and a plurality of respective first cluster times respectively associated with the plurality of first clusters, wherein each of the plurality of first clusters represents a subset of the plurality of first images;
obtaining, based on the plurality of first clusters, a plurality of first setting representations;
determining a first path and a plurality of respective first locations for the plurality of first setting representations along the first path, wherein the first path is defined by an ordered set of first locations including the plurality of respective first locations in an order based on the plurality of respective first cluster times; and
displaying a map including the plurality of first setting representations displayed at the plurality of respective first locations, wherein each of the plurality of first setting representations is associated with an affordance which, when selected, causes display of a respective first setting.

23. The method of claim 22, further comprising:
obtaining a plurality of second images associated with a second user, wherein each of the plurality of second images is further associated with a respective second time and a respective second location;
determining, from the respective second times and respective second locations, a plurality of second clusters and a plurality of respective second cluster times respectively associated with the plurality of second clusters, wherein each of the plurality of second clusters represents a subset of the plurality of second images;
obtaining, based on the plurality of second clusters, a plurality of second setting representations; and
determining a second path and a plurality of respective second locations for the plurality of second setting representations along the second path, wherein the second path is defined by an ordered set of second locations including the plurality of respective second locations in an order based on the plurality of respective second cluster times;
wherein the map includes the plurality of second setting representation displayed at the plurality of respective second locations, wherein each of the plurality of second setting representations is associated with an affordance which, when selected, causes display of a respective second setting.

24. The method of claim 23, wherein the ordered set of second locations further includes one of the respective first locations within the order based on the plurality of respective second cluster times.

25. The method of claim 24, further comprising:
receiving user input indicative of a selection of an associated affordance of the one of the plurality of first setting representations at the one of the respective first locations; and
in response to receiving the user input, displaying the corresponding setting.

26. The method of claim 25, wherein displaying the corresponding setting includes:
in accordance with a determination that displaying the corresponding setting is associated with a first time, displaying at least one virtual object based on the first plurality of images; and
in accordance with a determination that displaying the corresponding setting is associated with a second time, displaying at least one virtual object based on the second plurality of images.

27. The method of claim 22, wherein at least one of the plurality of first clusters is determined based on a number of images of the plurality of first images at a particular location.

28. The method of claim 22, wherein at least one of the plurality of first clusters is determined based on a time span of a number of images of the plurality of first images at a particular location.

29. The method of claim 22, wherein at least one of the plurality of first clusters is determined based on metadata regarding the first user.

30. The method of claim 29, wherein the metadata regarding the first user includes a home location.

31. The method of claim 22, wherein at least one of the plurality of first clusters is determined based on a tagged event associated with a subset of the plurality of first images.

32. The method of claim 22, wherein obtaining the plurality of first images associated with the first user includes receiving a user input from the first user to access a photo storage associated with the first user.

33. The method of claim 22, wherein obtaining the plurality of first images associated with the first user includes receiving a user input from the first user to access a social media account associated with the first user.

34. The method of claim 22, wherein obtaining a particular first setting representation of the plurality of first setting representations includes selecting the particular first setting representation from a plurality of stored setting representations based on a respective cluster location of a corresponding cluster of the plurality of first clusters.

35. The method of claim 22, wherein the number of first setting representations is less than the number of first clusters.

36. The method of claim 22, wherein determining the first path and the plurality of respective first locations includes determining the first path and determining the plurality of respective first locations after determining the first path.

37. The method of claim 22, wherein determining the first path and the plurality of respective first locations includes determining the plurality of respective first locations and determining the first path after determining the plurality of respective first locations.

38. The method of claim 22, wherein the first path is defined by a set of ordered locations that includes the same location two or more times.

39. A device comprising:
a non-transitory memory; and
one or more processors to:
obtain a plurality of first images associated with a first user, wherein each of the plurality of first images is further associated with a respective first time and a respective first location;
determine, from the respective first times and respective first locations, a plurality of first clusters and a plurality of respective first cluster times respectively associated with the plurality of first clusters, wherein each of the plurality of first clusters represents a subset of the plurality of first images;
obtain, based on the plurality of first clusters, a plurality of first setting representations;
determine a first path and a plurality of respective first locations for the plurality of first setting representations along the first path, wherein the first path is defined by an ordered set of first locations including the plurality of respective first locations in an order based on the plurality of respective first cluster times; and
display a map including the plurality of first setting representations displayed at the plurality of first respective locations, wherein each of the plurality of first setting representations is associated with an affordance which, when selected, causes display of a respective first setting.

40. The device of claim 39, wherein the one or more processors are further to:
obtain a plurality of second images associated with a second user, wherein each of the plurality of second images is further associated with a respective second time and a respective second location;
determine, from the respective second times and respective second locations, a plurality of second clusters and a plurality of respective second cluster times respectively associated with the plurality of second clusters, wherein each of the plurality of second clusters represents a subset of the plurality of second images;
obtain, based on the plurality of second clusters, a plurality of second setting representations; and
determine a second path and a plurality of respective second locations for the plurality of second setting representations along the second path, wherein the second path is defined by an ordered set of second locations including the plurality of respective second locations in an order based on the plurality of respective second cluster times;
wherein the map includes the plurality of second setting representation displayed at the plurality of respective second locations, wherein each of the plurality of second setting representations is associated with an affordance which, when selected, causes display of a respective second setting.

41. A non-transitory computer-readable medium having instructions encoded thereon which, when executed by one or more processors of a device, cause the device to:
obtain a plurality of first images associated with a first user, wherein each of the plurality of first images is further associated with a respective first time and a respective first location;
determine, from the respective first times and respective first locations, a plurality of first clusters and a plurality of respective first cluster times respectively associated with the plurality of first clusters, wherein each of the plurality of first clusters represents a subset of the plurality of first images;
obtain, based on the plurality of first clusters, a plurality of first setting representations;
determine a first path and a plurality of respective first locations for the plurality of first setting representations along the first path, wherein the first path is defined by an ordered set of first locations including the plurality of respective first locations in an order based on the plurality of respective first cluster times; and
display a map including the plurality of first setting representations displayed at the plurality of first respective locations, wherein each of the plurality of first setting representations is associated with an affordance which, when selected, causes display of a respective first setting.
